(19) United States
(12) Patent Application Publication
(10) Pub. No.: US 2007/0085060 A1
(43) Pub. Date: Apr. 19, 2007

(54) Method of making a fire extinguishing chemical

(76) Inventors: Dario Santoro, Port Jefferson, NY (US); Harry Shaw, Rockville, MD (US)

Correspondence Address: Dario Santoro, 17 Laurita Gate, Port Jefferson, NY, 11777, US

(21) Appl. No.: 11/253,114

(22) Filed: Oct. 18, 2005

(51) Int. Cl. H01B 1/12

(52) U.S. Cl. 252/500

(57) ABSTRACT

A non-ambient pressuring-dependent fire extinguishing chemical that includes a fire retardant, a foament, a preservative, and a carrier. The fire retardant is potassium citrate in a range of approximately 30% to approximately 60% by weight, preferably 42.86% by weight. The foament is sodium bicarbonate in a range of approximately 3% to approximately 10% by weight, preferably approximately 5.04% by weight. The preservative is citric acid in a range of approximately 1% to approximately 3% by weight, preferably approximately 1.68% by weight. The carrier is water, preferably deionized water in a range of approximately 40% to approximately 60% by weight, preferably approximately 50.42% by weight.

### BACKGROUND OF THE INVENTION

1. Field of the Invention

The present invention relates to a method of making a fire extinguishing chemical and the fire extinguishing chemical, and more particularly, the present invention relates to a method of making a non-ambient pressuring-dependent fire extinguishing chemical and the non-ambient pressuring-dependent fire extinguishing chemical.

2. Description of the Prior Art

Numerous innovations for fire extinguishing compounds and compositions are known, such as carbon dioxide, liquid extinguishing compositions, and powder sprays, that will be described infra. Even though these innovations may be suitable for the specific individual purposes to which they address, they differ from the present invention.

Fluorine-containing fire extinguishing compounds are taught by U.S. Pat. No. 3,849,315; U.S. Pat. No. 3,752,234; U.S. Pat. No. 3,952,075; U.S. Pat. No. 3,957,658; and U.S. Pat. No. 4,038,195. Polyfuran foam fire extinguishing compositions are taught by U.S. Pat. No. 3,975,318 and U.S. Pat. No. 3,975,319. Foams for use in fire fighting are taught by U.S. Pat. No. 3,616,859; U.S. Pat. No. 3,684,018; U.S. Pat. No. 3,750,754; U.S. Pat. No. 4,060,489; and U.S. Pat. No.3,929,649. Other fire fighting compositions are taught by U.S. Pat. No. 4,076,540 and U.S. Pat. No. 4,173,538.

U.S. Pat. No. 4,756,839 teaches a fire extinguishing composition including potassium carbonate, a boron-containing compound, water and optionally a potassium salt of an organic acid. U.S. Pat. No. 5,945,025 to Cunningham teaches a fire fighting composition including sodium bicarbonate, potassium bicarbonate and a potassium salt of an organic acid having 1 to 6 carbon atoms, such as potassium citrate. When mixed with water, the composition can be sprayed as a solution on fires.

### SUMMARY OF THE INVENTION

ACCORDINGLY, AN OBJECT of the present invention is to provide a method of making a non-ambient pressuring-dependent fire extinguishing chemical and the non-ambient pressuring-dependent fire extinguishing chemical that avoids the prior art.

ANOTHER OBJECT of the present invention is to provide a method of making a non-ambient pressuring-dependent fire extinguishing chemical and the non-ambient pressuring-dependent fire extinguishing chemical that is simple to use.

BRIEFLY STATED, STILL ANOTHER OBJECT of the present invention is to provide a non-ambient pressuring-dependent fire extinguishing chemical that includes a fire retardant, a foament, a preservative, and a carrier. The fire retardant is potassium citrate in a range of approximately 30% to approximately 60% by weight, preferably 42.86% by weight. The foament is sodium bicarbonate in a range of approximately 3% to approximately 10% by weight, preferably approximately 5.04% by weight. The preservative is citric acid in a range of approximately 1% to approximately 3% by weight, preferably approximately 1.68% by weight. The carrier is water, preferably deionized water in a range of approximately 40% to approximately 60% by weight, preferably approximately 50.42% by weight.

The novel features which are considered characteristic of the present invention are set forth in the appended claims. The invention itself, both as to its construction and its method of operation, together with additional objects and advantages thereof, will be best understood from the following description of the specific embodiment when read and understood in connection with the accompanying drawing.

### BRIEF DESCRIPTION OF THE DRAWING

The figures are briefly described as follows:

FIGS. 1A-1D are a flow chart for making the non-ambient pressuring-dependent fire extinguishing chemical of the present invention.

### LIST OF REFERENCE NUMERALS UTILIZED IN THE DRAWING

10 method of making a non-ambient pressuring-dependent fire extinguishing chemical
12 batching tank
14 hopper
16 filter
18 water
20 potassium citrate
22 first composition
24 mixed first composition
26 sodium bicarbonate
28 second composition
32 mixed second composition
34 citric acid
36 third composition
38 mixed third composition
40 1 micron filter

### DETAILED DESCRIPTION OF THE PREFERRED EMBODIMENT

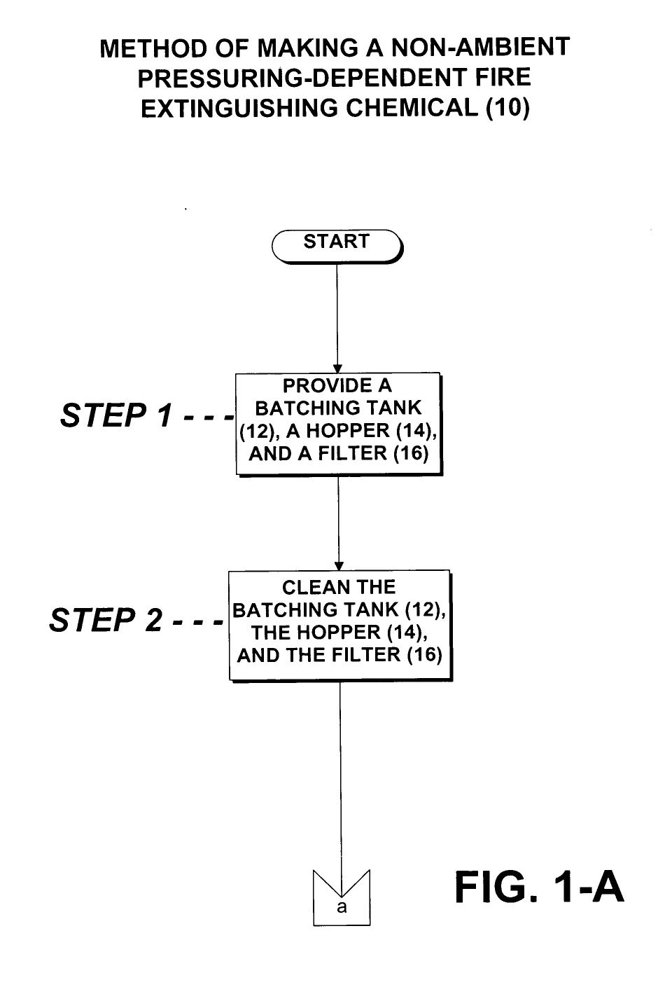

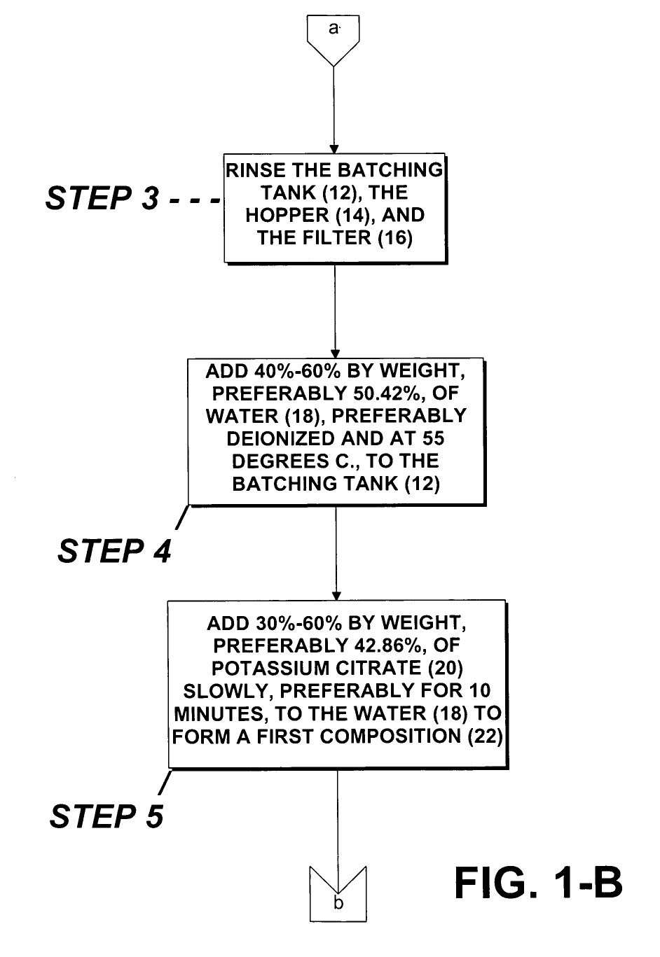

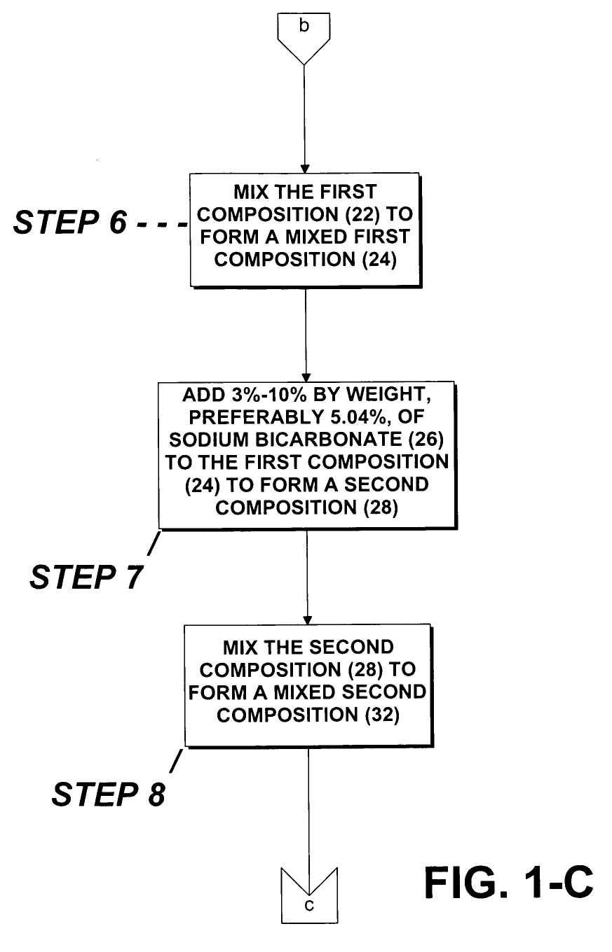

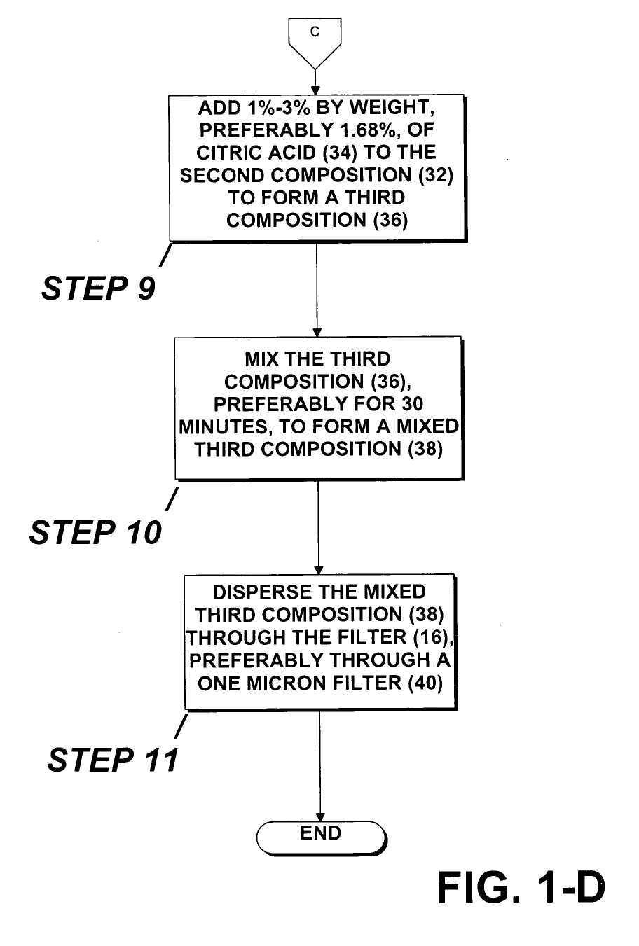

Referring now to FIGS. 1A-1D, which are a flow chart for making the non-ambient pressuring-dependent fire extinguishing chemical of the present invention, the method of making a non-ambient pressuring-dependent fire extinguishing chemical 10 comprises the steps of:

STEP 1: Provide a batching tank 12, a hopper 14, and a filter 16.

STEP 2: Clean the batching tank 12, the hopper 14, and the filter 16.

STEP 3: Rinse the batching tank 12, the hopper 14, and the filter 16.

STEP 4: Add approximately 40% to approximately 60% by weight, preferably approximately 50.42%, of water 18, preferably deionized water at approximately 55 degrees C., to the batching tank 12. NOTE 1: <approximately 40% prevents uniform mixing of ingredients. NOTE 2: >approximately 60% reduces effectiveness of chemical and increases cost of shipping without benefit.

STEP 5: Add approximately 30% to approximately 60% by weight, preferably approximately 42.86%, of a fire retardant, preferably potassium citrate 20, slowly, preferably for approximately 10 minutes, to the water 18 to form a first composition 22. NOTE 1: <approximately 30% reduces effectiveness of fire extinguishing to a level that is not viable. NOTE 2: >approximately 60% prevents total mixing of chemical.

STEP 6: Mix the first composition 22 to form a mixed first composition 24.

STEP 7: Add approximately 3% to approximately 10% by weight, preferably approximately 5.04%, of a foament, preferably sodium bicarbonate 26, to the first composition 24 to form a second composition 28. NOTE 1: <approximately 3% prevents formation of a foam insulating layer between the fire and the ambient. NOTE 2: >approximately 10% decreases amount of potassium citrate available for use in the chemical to a level that is not viable for fire extinguishing.

STEP 8: Mix the second composition 28 to form a mixed second composition 32.

STEP 9: Add approximately 1% to approximately 3% by weight, preferably approximately 1.68%, of a preservative, preferably citric acid 34, to the second composition 32 to form a third composition 36. NOTE 1: <approximately 1% not effective as a preservative. NOTE 2: >approximately 3% reduces overall effectiveness of chemical.

STEP 10: Mix the third composition 36, preferably for approximately 30 minutes, to form a mixed third composition 38.

STEP 11: Disperse the mixed third composition 38 through the filter 16, preferably through approximately 1 micron filter 40. NOTE: >approximately 1 micron will allow solids to pass therethrough that will ultimately clog the nozzles used to discharge the chemical.

The ingredients utilized, their functions, ranges, and optimum amounts supra have been summarized in TABLE I infra.

TABLE I

| | | RANGE | OPTIMUM |
|---|---|---|---|
| INGREDIENT | FUNCTION | (% BY WEIGHT) | (% BY WEIGHT) |
| Potassium | Fire | Approx. 30 to | Approx. 42.86 |
| Citrate | Regardant | Approx. 60 | |
| Sodium | Foament | Approx. 3 to | Approx. 5.04 |
| Bicarbonate | | Approx. 10 | |
| Citric Acid | Preservative | Approx. 1 to | Approx. 1.68 |
| | | Approx. 3 | |
| Deionized Water | Carrier | Approx. 40 to | Approx. 50.42 |
| | | Approx. 60 | |

It will be understood that each of the elements described above or two or more together may also find a useful application in other types of constructions differing from the types described above.

While the invention has been illustrated and described as embodied in a method of making a non-ambient pressuring-dependent fire extinguishing chemical and the non-ambient pressuring-dependent fire extinguishing chemical, it is not limited to the details shown, since it will be understood that various omissions, modifications, substitutions, and changes in the forms and details of the device illustrated and its operation can be made by those skilled in the art without departing in any way from the spirit of the present invention.

Without further analysis, the foregoing will so fully reveal the gist of the present invention that others can by applying current knowledge readily adapt it for various applications without omitting features that from the standpoint of prior art fairly constitute characteristics of the present invention.

The invention claimed is:

1. A non-ambient pressuring-dependent fire extinguishing chemical, comprising:
a) a fire retardant;
b) a foament;
c) a preservative; and
d) a carrier.

2. The chemical as defined in clam 1, wherein said fire retardant is potassium citrate.

3. The chemical as defined in clam 2, wherein said potassium citrate is in a range of approximately 30% to approximately 60% by weight.

4. The chemical as defined in clam 2, wherein said potassium citrate is approximately 42.86% by weight.

5. The chemical as defined in clam 1, wherein said foament is sodium bicarbonate.

6. The chemical as defined in clam 5, wherein said sodium bicarbonate is in a range of approximately 3% to approximately 10% by weight.

7. The chemical as defined in clam 5, wherein said sodium bicarbonate is approximately 5.04% by weight.

8. The chemical as defined in clam 1, wherein said preservative is citric acid.

9. The chemical as defined in clam 8, wherein said citric acid is in a range of approximately 1% to approximately 3% by weight.

10. The chemical as defined in clam 8, wherein said citric acid is approximately 1.68% by weight.

11. The chemical as defined in clam 1, wherein said carrier is water.

12. The chemical as defined in clam 11, wherein said water is deionized water.

13. The chemical as defined in clam 12, wherein said deionized water is in a range of approximately 40% to approximately 60% by weight.

14. The chemical as defined in clam 12, wherein said deionized water is approximately 50.42% by weight.

15. A method of making a non-ambient pressuring-dependent fire extinguishing chemical, comprising the steps of:
a) adding a fire retardant to water to form a first composition;
b) adding a foament to the first composition to form a second composition; and
c) adding a preservative to the second composition to form a third composition.

16. The method as defined in claim 15, further comprising the step of dispersing the third composition through a filter.

17. The method as defined in claim 15, wherein said first adding step includes adding potassium citrate to water to form the first composition.

18. The method as defined in claim 15, wherein said first adding step includes adding approximately 30% to approximately 60% by weight of potassium citrate to water to form the first composition.

19. The method as defined in claim 15, wherein said first adding step includes adding approximately 42.86% by weight of potassium citrate to water to form the first composition.

20. The method as defined in claim 15, wherein said second adding step includes adding sodium bicarbonate to the first composition to form the second composition.

21. The method as defined in claim 15, wherein said second adding step includes adding approximately 3% to approximately 10% by weight of sodium bicarbonate to the first composition to form the second composition.

22. The method as defined in claim 15, wherein said second adding step includes adding approximately 5.04% by weight of sodium bicarbonate to the first composition to form the second composition.

23. The method as defined in claim 15, wherein said third adding step includes adding citric acid to the second composition to form the third composition.

24. The method as defined in claim 15, wherein said third adding step includes adding approximately 1% to approximately 3% by weight of citric acid to the second composition to form the third composition.

25. The method as defined in claim 15, wherein said third adding step includes adding approximately 1.68% by weight of citric acid to the second composition to form the third composition.

26. The method as defined in claim 15, wherein said first adding step includes adding a fire retardant to deionized water to form the first composition.

27. The method as defined in claim 15, wherein said first adding step includes adding a fire retardant to approximately 40% to approximately 60% by weight of deionized water to form the first composition.

28. The method as defined in claim 15, wherein said first adding step includes adding a fire retardant to approximately 50.42% by weight of deionized water to form the first composition.

29. The method as defined in claim 15, wherein said first adding step includes adding a fire retardant to 55 degrees C. deionized water to form the first composition.

30. The method as defined in claim 15, further comprising the step of mixing the third composition for 30 minutes.

31. The method as defined in claim 15, wherein said first adding step includes adding the fire retardant slowly for approximately 10 minutes to the water to form the first composition.

32. The method as defined in claim 15, wherein said dispersing step includes dispersing the third composition through an approximately 1 micron filter.
